(19) United States
(12) Patent Application Publication
(10) Pub. No.: US 2021/0368848 A1
(43) Pub. Date: Dec. 2, 2021

(54) FOAMED FOODS

(71) Applicant: Clayton Corporation, Fenton, MO (US)

(72) Inventors: Mark Baker, Saint Louis, MO (US); Kevin Robert Martz, Desoto, MO (US)

(21) Appl. No.: 17/290,860

(22) PCT Filed: Oct. 2, 2020
(86) PCT No.: PCT/US2020/054061

§ 371 Date: May 3, 2021

Related U.S. Application Data
(60) Provisional application No. 62/910,782, filed on Oct. 4, 2019.

(51) Int. Cl. A23P 30/40; A23L 25/00; A23L 11/00; A23D 7/005; B65D 83/14

(52) U.S. Cl. CPC A23P 30/40; A23L 25/30; B65D 83/752; A23D 7/0056; A23L 11/05

(57) ABSTRACT

The invention relates to a containerization system for dispensing a foamable food product comprising a single chamber pressure-resistant container comprising a base, a sidewall, and a nozzle, a food product composition comprising a food product and water, and a propellant. The invention is also directed to a process wherein the food product composition and propellant are combined to form a foamable mixture and the foamable mixture is disposed within a container such that the mixture expands in volume when it is released from the container, forming a foamed food product.

### FIELD OF THE INVENTION

This invention relates to a containerized food product and methods of releasing the food product from a container in order to prepare a foamed food product. The invention further relates to foamable food mixtures suitable for preparing a foamed food product.

### BACKGROUND OF THE INVENTION

Pressurized containers (e.g., aerosol containers) which dispense products have found wide application in the field of food products, from dispensing cheese products to whipped cream. For example, EASY CHEESE® and REDDI-WIPO, respectively. The products are often packaged in aerosol cans with a pressurizing agent, which acts as a propellant for dispensing a liquid product. These aerosol cans include a dispensing valve that may be employed in dispensing a liquid as a foam product. Such valves may be intermittently operated to dispense small amounts of the product as needed. Typically, in such assemblies, nitrous oxide is used as the propellant. Nitrous oxide is a fat-soluble gas and therefore substantially dissolves in fatty food products, e.g., cream. When the valve of the pressurized container is opened, the fatty product (e.g., cream) is forced from the nozzle under high pressure. Once this pressure is released from the product, the dissolved nitrous oxide expands into bubbles, transforming the fatty food product to its whipped form.

A problem exists when attempting to containerize a high oil content food product. For example, a food product capable of separating into an oil phase and at least one additional phase. Problematically, when the oil content of the food product for containerization is too high, the formulation will leak or escape from the container valve when the contents are in contact with the valve. A similar problem is encountered with high viscosity food products. Viscous food products such as cheese spreads are generally provided in a container having the food product located above a barrier piston and propellant below the barrier piston. As the valve is activated and the food product is dispensed, the barrier piston advances within the container toward the valve. When attempting to prepare a containerized peanut butter formulation in such a container, oil leakage is a significant problem. In fact, under certain conditions, the peanut butter formulation will separate in the container into an oil phase and a peanut fiber phase and subsequently leak oil from the container through the valve.

There remains a need for a suitable high oil content and/or high viscosity food product, as well as a method or system of containerization where the food product can be held under pressure and suitably dispersed as a foamed food product while avoiding the problems known in the field.

### BRIEF SUMMARY OF THE INVENTION

Provided herein is a high oil content and/or high viscosity food product that is suitable for containerization and dispensing from a container as a foamed food product. The invention also relates to a containerization system wherein the high oil content and/or high viscosity food product is loaded into a container and suitably dispensed as a foam food product. The compositions and systems of the invention are storage stable and satisfy other commercially necessary characteristics, e.g., taste, texture, mouthfeel, etc.

Briefly, therefore, the invention is directed to a containerization system for dispensing a foamed food product wherein the container is a single chamber pressure-resistant container comprising a base, a sidewall, and a nozzle. The system comprises a propellant and a food product composition comprising from about 30 wt. % to about 80 wt. % of a food product capable of separating into an oil phase and at least one additional phase, and from about 20 wt. % to about 70 wt. % of a diluent. The propellant and the food product composition are sealed within the single chamber of the container. At least a portion of the propellant is capable of settling above the food product composition when the container is in an unshaken and upright position. The oil phase does not leak from the nozzle of the container during storage of the system. The food product composition is capable of forming a foamable food mixture with at least a portion of the propellant when the container is shaken. The foamable food mixture is capable of flowing toward the nozzle of the container upon inversion of the container after the container is shaken so that the foamable food mixture is dispensed from the nozzle when the nozzle is activated. The foamable food mixture is capable of expanding in volume when it is dispensed from the nozzle, forming a foamed food product.

In other embodiments, the invention is directed to the containerization system wherein the food product composition comprises a food product comprising a sugar and a diluent comprising water and oil.

Typically, the container nozzle comprises a dispensing valve. When the valve is opened, the foamable food mixture is forced from the nozzle under high pressure. Once this pressure is released from the container, the dissolved propellant expands into bubbles, transforming the foamable food mixture into its foamed form.

The invention overcomes the problems known in the art by allowing for the containerization and dispensing of a high oil content and/or high viscosity food product in the form of a foam without the formulation leaking from the container when not in use. For example, the invention particularly solves issues known in the art with respect to the containerization of legume based food products such as peanut butter, nut based food products such as almond butter, or guacamole or avocado-based food products.

In particular, this is achieved by mixing the high oil content (i.e. capable of separating into an oil phase and at least one additional phase) and/or high viscosity food product with a diluent in order to dilute the food product and form a food product composition. Multiple benefits are achieved by this process. Such a process reduces the viscosity of the high oil content and/or high viscosity food product and allows for the propellant to be more easily dissolved into the food product. Dilution of the food product also results in lowered processing costs, processing time, and a more uniform foamed product. Additionally, dilution of the food product prior to containerization reduces the total amount of food product in a given container and typically results in a lighter final product. This provides the commercial benefit of reduced shipping and transportation costs. From a consumer perspective, the use of a reduced amount of the food product in a given container also results in a product having a lower caloric content per serving as compared to the caloric content of a serving of the food product alone.

Therefore, the invention not only solves the problems of containerizing and dispensing a foamed high oil content and/or high viscosity food product, but also a desirable commercial product.

Other objects and features will be in part apparent and in part pointed out hereinafter.

### BRIEF DESCRIPTION OF THE DRAWINGS

FIG. 1 provides an example of a single chamber pressure-resistant container comprising a base, a cylindrical sidewall, and a nozzle.

FIG. 2 provides an alternative view of a single chamber pressure-resistant container comprising a base, a cylindrical sidewall, and a nozzle.

FIG. 3 provides an example of a nozzle configuration comprising a valve.

### DETAILED DESCRIPTION OF THE INVENTION

Prior to the invention, it was not possible to containerize a high oil content (i.e. capable of separating into an oil phase and at least one additional phase) and/or high viscosity food product in order to dispense the product as a foamed food product. Particularly in the context of high oil content food products, when the oil content of the food product is too high the formulation will leak or escape from the container valve when the contents are in contact with the valve. This problem is particularly prevalent when attempting to prepare a containerized legume-based food product such as peanut butter.

It has been discovered that dilution of the food product prior to containerization overcomes these previous deficiencies and provides several benefits. Dilution of the food product, for example with water, reduces the viscosity of the high oil content and/or high viscosity food product, forming a food product composition. The food product composition and a propellant are then loaded into the single chamber pressure-resistant container. The initial dilution of the food product allows for the propellant to more easily be dissolved into the resulting food product composition.

In contrast to the prior configurations in which the high oil content food product was prone to leaking from the valve, the invention results in a configuration in which the high oil content food product has been diluted and the propellant (not the food product or diluent) is pressing against the nozzle when not in use. This results in a pressure barrier between the food product and nozzle that prevents leaking of the food product from the container. When the product is ready to be dispensed, the can is shaken to ensure the propellant has adequately mixed and/or dissolved in the food product composition, forming a foamable food mixture. The container is then inverted such that the valve is in a position to dispense the foamable food mixture. The foamable food mixture then flows to the end of the container which houses the valve/nozzle. The nozzle is then activated and the foamable food mixture is dispensed. Once the product is released from the container, the dissolved propellant expands into bubbles, transforming the foamable food mixture into a foamed food product.

Since the high oil content and/or high viscosity food product has been diluted, the contents of the container are able to flowably move from one end of the container to the other when the can is tilted or inverted for dispensing the food product. Therefore, the described containerization system not only prevents leakage of the product during storage but also allows for dispensing of a consistent product from the container in a commercially acceptable amount of time without undesired loss of propellant from the can (as would occur if the food product did not flow against the valve before the valve was activated).

Further, the use of a single chamber pressure-resistant container necessitates that during storage the propellant and diluted food product (i.e. the food product composition comprising a food product and diluent) are in direct contact. Prior containerization systems comprising more than one chamber or a “bag-in-can” configuration encountered the problem of oil separation, leading to leaking through the sealing surfaces of the container. This was particularly prevalent in previous attempts to create a containerized peanut butter food product. In the present configuration the propellant forms a pressure barrier at the top of the container, ensuring that the diluted food product is not susceptible to oil separation and subsequent leaking through the seals of the container. Another benefit of the present configuration is that the container can be substantially free of oxygen since the propellant is in the same chamber as the food product. The containerized foamable food mixture is thus storage stable at room temperature and for a longer period of time, and is not required to contain preservatives since the food product is not subject to oxidation when the propellant is inert. Further, the containerized system does not need to be refrigerated or otherwise preserved when transporting and storing the product or after initial or subsequent use.

Dilution of the food product also results in lower processing costs, processing time, and a more uniform foamed product. Additionally, dilution of the food product reduces the total amount of food product in a given container and typically results in a lighter final product. This provides the commercial benefit of reduced shipping and transportation costs as well as the consumer benefit of reduced caloric content per serving. Since the foamed food product is less dense than the conventional food product (e.g., peanut butter), the same area of coverage can be obtained with significantly less product using the system of the invention.

The invention is directed to a containerization system for dispensing a foamed food product from a single chamber pressure-resistant container comprising a base, a sidewall, and a nozzle.

The system further comprises a propellant and a food product composition within the single chamber of the container. The food product composition comprises from about 30 to about 80 wt. % of a food product and from about 20 to about 70 wt. % of a diluent.

When the container is shaken, the food product, diluent, and propellant are combined to form a foamable food mixture and the foamable food mixture expands in volume when it is released from the container, forming a foamed food product.

In the context of the invention, “foam,” “foamed,” “foamable,” “whipped,” and similar terms are understood to refer to a product that is capable of expanding in volume when released from a pressurized container.

The term “high oil content” means that the food product is capable of separating into an oil phase and at least one additional phase.

In selecting a suitable food product for the present containerization system, the melting point of the food product may be an important consideration. It has been discovered that, in some embodiments, food products having a melting point of between about 75° F. and about 90° F. result in a food product composition and final foamed food product having the desired properties (e.g., viscosity and/or mouthfeel). For example, in certain embodiments, a food product may be selected having a melting point of between about 75° F. and about 90° F., between about 80° F. and about 90° F., or between about 85° F. and about 90° F. Where the containerization system is intended to be stored at refrigerated temperatures, a food product may be selected having a melting point of between about 38° F. and about 45° F. When the product is intended to be frozen for storage, a food product may be selected having a melting point of between about −4° F. and about 38° F.

The food product may comprise a legume-based food product. For example, the food product may comprise beans, clovers, peas, lentils, lupins, mequites, or combinations thereof. In certain embodiments, the food product may comprise alfalfa, chickpeas (i.e. Bengal gram, garbanzo bean, or Egyptian pea), carob, soybeans, peanuts, tamarind, or combinations thereof. In certain other embodiments, the food product may comprise a legume selected from the group consisting of chickpeas, soybeans, peanuts, or combinations thereof. In one embodiment, the food product comprises chickpeas. In a further embodiment, the food product is hummus. In another embodiment, the food product comprises peanuts. In yet another embodiment, the food product is peanut butter.

The food product may comprise a nut-based food product. For example, almond butter, cashew butter, pecan butter, coconut butter, and hazelnut butter are suitable food products for use in the system of the invention.

The food product may be a berry-based food. For example, the food product may be an avocado-based product such as guacamole.

The food product may comprise a high viscosity diary based product. For example, the food product may be cream cheese.

The food product may comprise a non-protein food. For example, the food product may be a food comprising a sugar. In certain embodiments, the food product may comprise taffy, marshmallow, nougat, caramel, jam, syrup, or any combination thereof. In one embodiment, the food product comprises sucrose.

Preferably, the food product comprises a legume butter such as peanut butter, a nut butter such as almond butter, an avocado-based food product such as guacamole, cream cheese, or sour cream.

When the food product is a legume-based food product, the food product can comprise various additives such as a nut, legume, seed, sweetener, emulsifier, preservative, flavorant, colorant, humectant, wetting agent, binder, stabilizer, rheology modifying agent, oil, or any combination thereof.

When the food product is a nut-based food product, the food product can comprise various additives such as a nut, legume, seed, sweetener, emulsifier, preservative, flavorant, colorant, humectant, wetting agent, binder, stabilizer, rheology modifying agent, oil, or any combination thereof.

When the food product is an avocado-based food product, the food product can contain various additives such as avocado meat, fruit juice, an herb, a fruit, a vegetable, sweetener, emulsifier, preservative, flavorant, colorant, humectant, wetting agent, binder, stabilizer, rheology modifying agent, oil, or any combination thereof.

When the food product is cream cheese or sour cream, the food product can contain various additives such as milk, cream, a sweetener, emulsifier, preservative, flavorant, colorant, humectant, wetting agent, binder, stabilizer, rheology modifying agent, oil, or any combination thereof.

The nuts used in the food product can include, for example, almonds, cashews, hazelnuts, brazil nuts, or any combination thereof. In other embodiments, the nuts used in the food product can include any tree nut.

The seeds used in the food product can include, for example, chia seeds, flax seeds, sunflower seeds, pumpkin seeds, sesame seeds, or any combination thereof.

The fruit juice used in the food product can include, for example, lime juice, lemon juice, or any combination thereof.

The herbs used in the food product can include, for example, cilantro, coriander, basil, or any combination thereof.

The fruits and/or vegetables used in the food product can include, for example, onion, jalapeno, tomato, or any combination thereof.

Generally, the food product composition may further comprise one or more additive selected from the group consisting of a sweetener, emulsifier, preservative, flavorant, colorant, humectant, wetting agent, binder, stabilizer, rheology modifying agent, oil, or combinations thereof.

The sweetener may be selected from the group consisting of a sugar, an artificial sweetener, a sugar alcohol, maple syrup, agave, stevia, or combinations thereof. The sugar may be selected from the group consisting of sucrose, fructose, glucose, molasses, or combinations thereof. In other embodiments, the sugar may be an inverted sugar syrup. The sugar alcohol may be selected from the group consisting of sorbitol, xylitol, or combinations thereof. The food product composition may comprise about 0.25 wt. % or greater, about 0.50 wt. % or greater, about 0.75 wt. % or greater, about 1 wt. % or greater, about 1.25 wt. % or greater, about 1.5 wt. % or greater, about 1.75 wt. % or greater, about 2 wt. % or greater, about 3 wt. % or greater, about 4 wt. % or greater, or about 5 wt. % or greater of a sweeter. For example, the food product composition may comprise from about 0.25 wt. % to about 10 wt. %, from about 0.25 wt. % to about 9 wt. %, from about 0.25 wt. % to about 8 wt. %, from about 0.25 wt. % to about 7 wt. %, from about 0.25 wt. % to about 6 wt. %, from about 0.25 wt. % to about 5 wt. %, from about 0.25 wt. % to about 4 wt. %, from about 0.5 wt. % to about 4 wt. %, from about 0.75 wt. % to about 4 wt. %, from about 1 wt. % to about 4 wt. %, from about 1 wt. % to about 3 wt. %, or from about 1 wt. % to about 2 wt. % of a sweetener.

The oil may be selected from the group consisting of peanut oil, rapeseed oil, soybean oil, cottonseed oil, palm oil, sunflower oil, coconut oil, or combinations thereof.

The emulsifier may be selected from the group consisting of monoglycerides, diglycerides, or combinations thereof. For example, the monoglycerides or diglycerides may be selected from the group consisting of DurEm 124, Alphadim 90 PBK, Grindsted ps 105 K-A, Grinsted Mono-di P 52 K-A, Grindsted PS 106 K-A, Trancendium 130, or combinations thereof. The emulsifier may also be selected from the group consisting of lecithin, polysorbate, Durtan 60, or combinations thereof. In certain embodiments the polysorbate may be Polysorbate 60. The food product composition may comprise about 0.25 wt. % or greater, about 0.50 wt. % or greater, about 0.75 wt. % or greater, about 1 wt. % or greater, about 1.25 wt. % or greater, about 1.5 wt. % or greater, about 1.75 wt. % or greater, about 2 wt. % or greater, about 3 wt. % or greater, about 4 wt. % or greater, or about 5 wt. % or greater of an emulsifier. For example, the food product composition may comprise from about 0.25 wt. % to about 10 wt. %, from about 0.25 wt. % to about 9 wt. %, from about 0.25 wt. % to about 8 wt. %, from about 0.25 wt. % to about 7 wt. %, from about 0.25 wt. % to about 6 wt. %, from about 0.25 wt. % to about 5 wt. %, from about 0.25 wt. % to about 4 wt. %, from about 0.5 wt. % to about 4 wt. %, from about 0.75 wt. % to about 4 wt. %, from about 1 wt. % to about 4 wt. %, from about 1 wt. % to about 3 wt. %, or from about 1 wt. % to about 2 wt. % of an emulsifier.

The flavorant may be selected from the group consisting of salt, chocolate, coconut, or combinations thereof.

The humectant may be selected from the group consisting of glycerol (glycerin), sorbitol, propylene glycol, butylene glycol, polydextrose, or combinations thereof. The food product composition may comprise about 1 wt. % or greater, about 2 wt. % or greater, about 3 wt. % or greater, about 4 wt. % or greater, about 5 wt. % or greater, about 6 wt. % or greater, about 7 wt. % or greater, about 8 wt. % or greater, about 9 wt. % or greater, or about 10 wt. % or greater of a humectant. For example, the food product composition may comprise from about 1 wt. % to about 15 wt. %, from about 1 wt. % to about 10 wt. %, from about 2 wt. % to about 10 wt. %, from about 3 wt. % to about 10 wt. %, from about 4 wt. % to about 10 wt. %, from about 5 wt. % to about 10 wt. %, from about 5 wt. % to about 9 wt. %, from about 5 wt. % to about 8 wt. %, from about 5 wt. % to about 7 wt. %, or from about 5 wt. % to about 6 wt. % of a humectant.

The stabilizer may be selected from the group consisting of xanthan gum, guar gum, locust bean gum, carboxymethyl cellulose, pectin, carrageenan, tic gum, pea protein, or combinations thereof. The food product composition may comprise about 0.1 wt. % or greater, about 0.2 wt. % or greater, about 0.3 wt. % or greater, about 0.4 wt. % or greater, about 0.5 wt. % or greater, about 0.6 wt. % or greater, about 0.7 wt. % or greater, about 0.8 wt. % or greater, about 0.9 wt. % or greater, about a wt. % or greater of a stabilizer. For example, the food product composition may comprise from about 0.1 wt. % to about 2 wt. %, from about 0.2 wt. % to about 2 wt. %, from about 0.3 wt. % to about 2 wt. %, from about 0.4 wt. % to about 2 wt. %, from about 0.5 wt. % to about 2 wt. %, or from about 0.5 wt. % to about 1 wt. % of a stabilizer.

The rheology modifying agent may be selected from the group consisting of gelatin, cellulose ethers, starch, starch esters, starch ethers, and combinations thereof.

The food product composition may also comprise further additives such as baking soda or coconut cream.

When the food product is containerized, the container typically comprises a food product composition comprising from about 30 to about 80 wt. % of a food product and from about 20 to about 70 wt. % of a diluent. In certain embodiments, the diluent comprises water.

The food product composition may comprise from about 30 wt. % to about 80 wt. %, from about 30 to about 75 wt. %, from about 35 to about 70 wt. %, from about 40 to about 70 wt. %, from about 40 to about 65 wt. %, from about 45 to about 65 wt. %, from about 45 to about 60 wt. %, or from about 50 to about 60 wt. % of a food product. For example, from about 40 to about 60 wt. %, from about 40 to about 55 wt. %, from about 40 to about 50 wt. %, or from about 45 to about 50 wt. % of a food product is suitable.

The food product composition may comprise from about 20 wt. % to about 70 wt. %, from about 20 wt. % to about 65 wt. %, from about 20 wt. % to about 60 wt. %, from about 20 wt. % to about 55 wt. %, from about 20 wt. % to about 50 wt. %, from about 20 wt. % to about 45 wt. %, from about 20 wt. % to about 40 wt. %, from about 20 wt. % to about 35 wt. %, from about 20 wt. % to about 30 wt. %, or from about 20 wt. % to about 25 wt. % of a diluent. For example, the food product composition may comprise from about 25 to about 65 wt. %, from about 25 to about 60 wt. %, from about 25 to about 55 wt. %, from about 25 to about 50 wt. %, from about 25 to about 45 wt. %, from about 25 to about 40 wt. %, or from about 25 to about 35 wt. % of the diluent. In certain other embodiments, the food product composition may comprise from about 20 to about 50 wt. %, from about 20 to about 40 wt. %, from about 25 to about 40 wt. %, from about 25 to about 35 wt. %, from about 26 to about 35 wt. %, from about 26 to about 34 wt. %, from about 27 to about 34 wt. %, from about 27 to about 33 wt. %, from about 28 to about 33 wt. %, from about 28 to about 32 wt. %, from about 29 to about 32 wt. %, or from about 30 to about 32 wt. % of the diluent.

In certain embodiments, the diluent comprises water. In additional embodiments, the diluent comprises oil. In further embodiments, the diluent comprises water and oil.

The oil diluent may be selected based on the melting point of the oil. When the product is intended to be stored at ambient conditions, it has been discovered that an oil diluent having a melting point near room temperature (i.e. about 72° F. to about 76° F.) results in a desirable final product. When the product is intended to be stored at refrigerated temperatures, an oil diluent melting point of about 38° F. to about 72° F. is preferred. When the product is intended to be frozen for storage, an oil diluent melting point of about −4° F. to about 38° F. is preferred. An oil diluent having such a melting point allows for the material within the container to maintain its liquid state, but form a semi-solid state when dispersed from the container. The release from the container results in a temperature drop due to the decompression of the material and causes the oil component to contribute to the semi-solid state of the final product.

When the diluent comprises oil, the oil may be selected from the group consisting of peanut oil, rapeseed oil, soybean oil, cottonseed oil, palm oil, sunflower oil, coconut oil or combinations thereof. The diluent may comprise from about 10 wt. % to about 99 wt. %, from about 15 wt. % to about 99 wt. %, from about 20 wt. % to about 99 wt. %, from about 25 wt. % to about 99 wt. %, from about 30 wt. % to about 99 wt. %, from about 35 wt. % to about 99 wt. %, from about 40 wt. % to about 99 wt. %, from about 45 wt. % to about 99 wt. %, from about 50 wt. % to about 99 wt. %, from about 55 wt. % to about 99 wt. %, from about 60 wt. % to about 99 wt. %, from about 65 wt. % to about 99 wt. %, from about 70 wt. % to about 99 wt. %, from about 75 wt. % to about 99 wt. %, from about 80 wt. % to about 99 wt. %, from about 85 wt. % to about 99 wt. %, from about 90 wt. % to about 99 wt. %, from about 90 wt. % to about 98 wt. %, from about 90 wt. % to about 97 wt. %, from about 90 wt. % to about 96 wt. %, from about 90 wt. % to about 95 wt. %, from about 91 wt. % to about 95 wt. %, from about 92 wt. % to about 95 wt. %, or from about 93 wt. % to about 95 wt. % of oil based on the total weight of the diluent. In other embodiments, when the diluent comprises oil, the diluent may comprise from about 20 wt. % to about 95 wt. %, from about 25 wt. % to about 95 wt. %, from about 30 wt. % to about 95 wt. %, from about 40 wt. % to about 95 wt. %, from about 50 wt. % to about 95 wt. %, from about 50 wt. % to about 90 wt. %, from about 50 wt. % to about 85 wt. %, from about 50 wt. % to about 80 wt. %, from about 55 wt. % to about 80 wt. %, from about 60 wt. % to about 80 wt. %, from about 65 wt. % to about 80 wt. %, or from about 70 wt. % to about 80 wt. % of oil based on the total weight of the diluent.

When the diluent comprises water, the diluent may comprise from about 1 wt. % to about 65 wt. %, from about 1 wt. % to about 60 wt. %, from about 1 wt. % to about 55 wt. %, from about 1 wt. % to about 50 wt. %, from about 1 wt. % to about 45 wt. %, from about 1 wt. % to about 40 wt. %, from about 1 wt. % to about 35 wt. %, from about 1 wt. % to about 30 wt. %, from about 1 wt. % to about 25 wt. %, from about 1 wt. % to about 20 wt. %, from about 1 wt. % to about 15 wt. %, from about 1 wt. % to about 10 wt. %, from about 2 wt. % to about 10 wt. %, from about 3 wt. % to about 10 wt. %, from about 4 wt. % to about 10 wt. %, or from about 5 wt. % to about 10 wt. % of water based on the total weight of the diluent. In certain embodiments, when the diluent comprises water, the diluent may comprise less than about 20 wt. %, less than about 10 wt. %, less than about 5 wt. %, less than about 4 wt. %, less than about 3 wt. %, less than about 2 wt. %, or less than about 1 wt. % of water based on the total weight of the diluent.

It may be desirable for the food product composition comprising the food product and diluent to have a certain water content. For purposes of determining the water content of the food product composition, the weight percentage of water includes any endogenous water in the food product and water exogenous from the food product. The water content can be determined by weighing the food product composition as prepared in comparison to the same composition after it has been dehydrated by heating the composition to 66° C. for 12 hours or 52° C. for 24 hours. For example, in some embodiments, the food product composition has a water content of from about 1 wt. % to about 65 wt. %, from about 1 wt. % to about 60 wt. %, from about 1 wt. % to about 55 wt. %, from about 1 wt. % to about 50 wt. %, from about 1 wt. % to about 45 wt. %, from about 1 wt. % to about 40 wt. %, from about 1 wt. % to about 35 wt. %, from about 1 wt. % to about 30 wt. %, from about 1 wt. % to about 25 wt. %, from about 1 wt. % to about 20 wt. %, from about 1 wt. % to about 15 wt. %, from about 1 wt. % to about 10 wt. %, from about 2 wt. % to about 10 wt. %, from about 3 wt. % to about 10 wt. %, from about 4 wt. % to about 10 wt. %, or from about 5 wt. % to about 10 wt. %, based on total weight of the food product composition.

In certain embodiments, the food product composition may have a water activity (aw) of about 0.8 or less, about 0.7 or less, about 0.6 or less, about 0.5 or less, about 0.4 or less, about 0.3 or less, or about 0.2 or less. For example, a water activity of from about 0.2 to about 0.8, from about 0.2 to about 0.7, from about 0.2 to about 0.6, from about 0.2 to about 0.5, from about 0.2 to about 0.4, or from about 0.2 to about 0.3. In other embodiments, the food product composition may have a water activity of from about 0.3 to about 0.8, from about 0.4 to about 0.8, from about 0.5 to about 0.8, or from about 0.5 to about 0.7.

In certain embodiments, the food product composition is an emulsion. Forming the food product composition as an emulsion may enhance the overall appearance of the final product and inhibit the “slump” of the final product. “Slump” is understood to refer to the tendency of the final product to lose its initial structure and rigidity. A final product quickly exhibiting slump or a deflation in appearance is typically commercially undesirable. It is believed that by forming an emulsion, the food product composition has a tendency to be a shear thickening composition. Therefore, the shearing action of the propellant escaping the food product mixture after it is dispensed from the container results in a stiffer final product. This, in turn, may enhance the appearance and volume of the dispensed product and delay the onset of slumping.

In certain other embodiments, the food product composition is not an emulsion.

The propellant can comprise air, carbon dioxide, nitrogen gas, nitrous oxide, 1,1,1,2-tetrafluoroethane (i.e., r134a), or any combination thereof. For example, the propellant can comprise carbon dioxide, nitrous oxide, or a combination thereof. Preferably, the propellant comprises nitrous oxide. It is understood that any suitable propellant for use with a food product, pursuant to local food regulations, may be utilized in the invention.

The propellant is generally in the form of a liquid, although it will be understood that a certain amount of the liquid may be in equilibrium with its gaseous form and/or that not all propellants described herein can be pressurized to a liquid. For example, compressed air will be present in its gaseous form.

The foamable food mixture comprising the food product composition and propellant can comprise more than about 80 wt. %, more than about 85 wt. %, more than about 90 wt. %, more than about 91 wt. %, more than about 92 wt. %, more than about 93 wt. %, more than about 94 wt. %, more than about 95 wt. %, more than about 95.5 wt. %, or more than about 96 wt. % of the food product composition, based on the total weight of the foamable food mixture. For example, the foamable food mixture can comprise from about 80 wt. % to about 96 wt. %, from about 85 wt. % to about 96 wt. %, from about 90 wt. % to about 96 wt. %, from about 91 wt. % to about 96 wt. %, from about 92 wt. % to about 96 wt. %, from about 93 wt. % to about 96 wt. %, from about 94 wt. % to about 96 wt. %, from about 95 wt. % to about 96 wt. %, or from about 95.5 wt. % to about 96 wt. % of the food product composition, based on the total weight of the foamable food mixture.

The foamable food mixture can comprise less than about 20 wt. %, less than about 15 wt. %, less than about 10 wt. %, less than about 9 wt. %, less than about 8 wt. %, less than about 7 wt. %, less than about 6 wt. %, less than about 5 wt. %, less than about 4.5 wt. %, or less than about 4 wt. % of the propellant, based of the total weight of the foamable food mixture. For example, the foamable food mixture can comprise from about 20 wt. % to about 4 wt. %, from about 15 wt. % to about 4 wt. %, from about 10 wt. % to about 4 wt. %, from about 9 wt. % to about 4 wt. %, from about 8 wt. % to about 4 wt. %, from about 7 wt. % to about 4 wt. %, from about 6 wt. % to about 4 wt. %, from about 5 wt. % to about 4 wt. %, or from about 4.5 wt. % to about 4 wt. % of the propellant, based on the total weight of the foamable food mixture.

The viscosity of the food product composition at 25° C. and atmospheric pressure of 1 bar is less than about 1,100,000 centipoise (cP), less than about 1,000,000 centipoise (cP), less than about 900,000 cP, less than about 800,000 cP, less than about 700,000 cP, less than about 600,000 cP, less than about 500,000 cP, less than about 400,000 cP, less than about 300,000 cP, less than about 200,000 cP, less than about 150,000 cP, less than about 100,000 cP, less than about 50,000 cP, less than about 25,000 cP, less than about 10,000 cP, less than about 5,000 cP, less than about 1,000 cP, less than about 750 cP, less than about 600 cP, less than about 500 cP, or less than about 450 cP. For example, the viscosity can be from about 450 to about 1,000,000 centipoise (cP), from about 500 to about 500,000 cP, from about 1,000 to about 500,000 cP, from about 5,000 to about 500,000 cP, from about 5,000 to about 250,000 cP, from about 10,000 to about 200,000 cP, from about 25,000 to about 100,000 cP, or from about 25,000 to about 50,000 cP. Even further, the viscosity can be from about 10,000 to about 200,000 cP, from about 25,000 to about 100,000 cP, or from about 25,000 to about 50,000 cP.

The viscosity of the food product composition impacts how easily the product flows over itself within the container and flows between the two ends of the container when turned. Another important consideration in formulating the food product composition and/or food product mixture (i.e. containing a mixture of the food product composition and propellant) is the stickiness of the mixture or the stiction of the mixture in contact with the container walls. Stiction (i.e. the static friction that must be overcome in order to enable relative motion of stationary objections in contact) is a useful factor for accounting for the amount of the food product mixture that will cling to the inside of the container. As the stiction increases, more of the mixture will be left inside of the container after all of the propellant has been expended. This can result in considerable waste. Reducing the stiction, while maintaining the desired viscosity of the mixture, is another goal of the present containerization system. Commercially acceptable stiction will result in about 10 wt. % or less of the mixture remaining in the container after the propellant has been expended. The present containerization system is able to achieve about 10 wt. % or less, about 9 wt. % or less, about 8 wt. % or less, about 7 wt. % or less, about 6 wt. % or less, or even about 5 wt. % or less of the mixture remaining in the container after the propellant has been expended.

The compositions and containerized compositions of the invention are generally storage stable. For example, the food product composition and the contents of the containerization system may be storage stable for at least about 1 day, at least about 5 days, at least about 1 week, at least about 2 weeks, at least about 1 month, at least about 2 months, at least about 4 months, at least about 6 months, at least about 1 year, or at least about 2 years when measured at a temperature of 25° C. and an atmospheric pressure of 1 bar. More particularly, in certain embodiments, the compositions and containerized compositions of the invention are storage stable at atmospheric pressure and a temperature of up to about 30° C. for a period of at least about 1 day, at least about 5 days, at least about 1 week, at least about 2 weeks, at least about 1 month, at least about 2 months, at least about 4 months, at least about 6 months, at least about 1 year, or at least about 2 years. In another embodiment, the compositions and containerized compositions of the invention are storage stable at atmospheric pressure and a temperature of as low as about −20° C. for a period of at least about 1 day, at least about 5 days, at least about 1 week, at least about 2 weeks, at least about 1 month, at least about 2 months, at least about 4 months, at least about 6 months, at least about 1 year, or at least about 2 years. For example, the compositions and containerized compositions of the invention may be storage stable at atmospheric pressure and a temperature of between about −20° C. and about 30° C., between about −10° C. and about 30° C., between about −5° C. and about 30° C., between about 0° C. and about 30° C., between about 0° C. and about 25° C., or between about 0° C. and about 20° C. for a period of at least about 1 day, at least about 5 days, at least about 1 week, at least about 2 weeks, at least about 1 month, at least about 2 months, at least about 4 months, at least about 6 months, at least about 1 year, or at least about 2 years.

The caloric content of a serving of the foamed food product (when dispensed from the container to form a foam) may represent less than about 90%, less than about 80%, less than about 70%, less than about 60%, less than about 50%, less than about 45%, less than about 40%, less than about 35%, less than about 30%, less than about 25%, less than about 20%, or less than about 15% of the caloric content of a traditional serving of the food product. For example, the caloric content of a serving of the foamed food product may represent from about 90% to about 15%, from about 80% to about 20%, from about 70% to about 15%, from about 60% to about 15%, from about 50% to about 15%, from about 50% to about 20%, from about 45% to about 20%, from about 40% to about 20%, from about 35% to about 20%, or from about 35% to about 25% of the caloric content of a traditional serving of the food product. A “traditional serving” of a food product means the food product without the diluent, propellant, and/or optional additives.

Certain high oil content food products do not readily mix with water at room temperature such as, for example, peanut butter, almond butter, cashew butter, pecan butter, hazelnut butter, coconut butter, etc. Therefore, the food product composition can be prepared by combining the food product and diluent at elevated temperature to form product food product composition. The food product composition and propellant are then loaded into a single chamber pressure-resistant container comprising a base, a sidewall, and a nozzle. For example, the food product may be heated to at least about 30° C., at least about 31° C., at least about 32° C., at least about 33° C., at least about 34° C., at least about 35° C., at least about 40° C., at least about 45° C., at least about 50° C., at least about 55° C., at least about 60° C., at least about 70° C., at least about 80° C., at least about 90° C., or at least about 100° C. For example, from about 30° C. to about 350° C., from about 30° C. to about 325° C., from about 30° C. to about 320° C., from about 30° C. to about 310° C., from about 30° C. to about 300° C., from about 30° C. to about 250° C., from about 30° C. to about 200° C., from about 30° C. to about 150° C., from about 30° C. to about 100° C., from about 30° C. to about 75° C., from about 30° C. to about 70° C., from about 30° C. to about 60° C., from about 40° C. to about 60° C., or from about 50° C. to about 60° C. is suitable. In the context of a peanut butter food product, the peanut butter is typically heated to at least about 30° C., at least about 31° C., or at least about 32° C. For example, from about 30° C. to about 100° C., from about 31° C. to about 75° C., or from about 32° C. to about 65° C. is suitable.

The containerized food product composition of the invention typically comprises from about 30 to about 80 wt. % of a food product and from about 20 to about 70 wt. % of a diluent. While dilution of the food product allows for reduction in weight, shipping costs, and/or total caloric content, the above values also generally define a food product that is readily foamed upon mixing with propellant and dispensing from the container while also maintaining commercially acceptable taste.

As discussed above, the food product composition is loaded into a container. The container is a single chamber pressure-resistant container comprising a base, a sidewall, and a nozzle. The container may be, for example, an aerosol can. The sidewall can be, for example, cylindrical. Typically, the nozzle comprises a dispensing valve. The valve may be intermittently operated to dispense small amounts of the foamable food mixture as needed. The propellant component of the foamable food mixture allows for the contents of the container to be dispensed as a foamed product. When the valve of the container is opened, the food product component (e.g., peanut butter) of the foamable food mixture is forced from the nozzle under high pressure. Once this pressure is released from the container, the dissolved propellant expands into bubbles, transforming the foamable food mixture into its whipped or foamed form.

As used throughout the disclosure with respect to the container, the terms defining relative locations and positions of structures and components of the container, including but not limited to the terms “inner,” “outer,” “upper,” “lower,” “top,” and “bottom,” are meant to provide a point of reference for such components and structures as shown in the drawings, with the understand that the respective relative locations of such components and structures will depend on the orientation of the container in use.

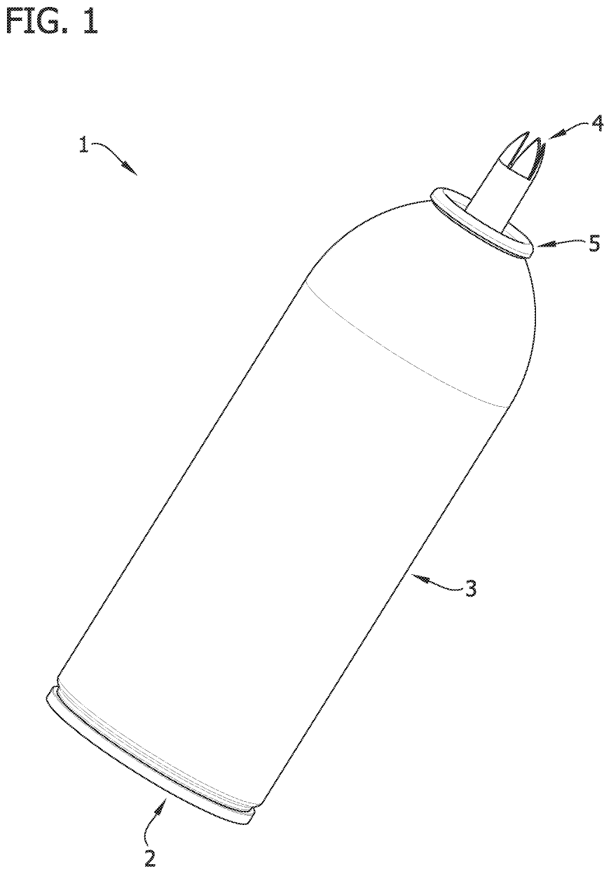

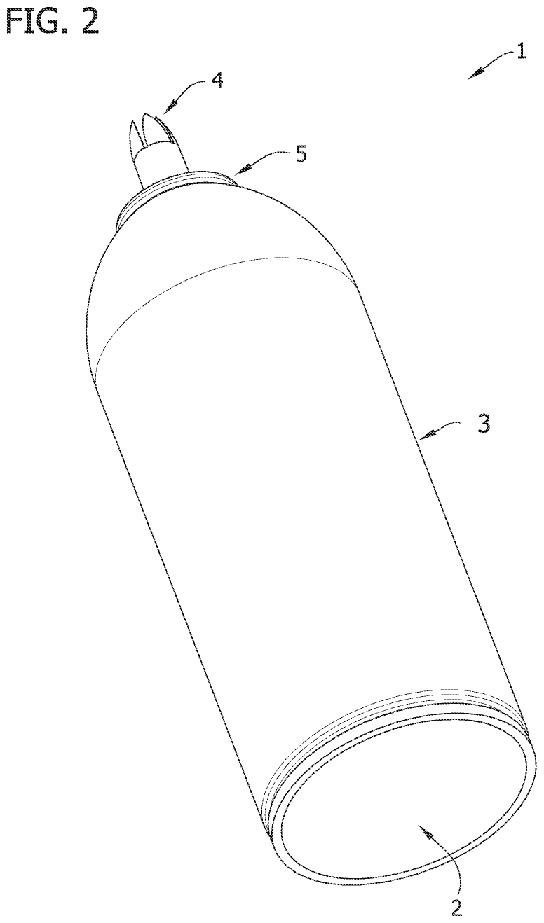

Referring to FIG. 1, container 1 is configured to store and dispense the foamable food mixture comprising a mixture of the food product composition and propellant. The illustrated container 1 generally includes a base 2, a cylindrical sidewall 3, and a nozzle 4. FIG. 2 shows an alternative view of the container, more clearly demonstrating the base 2.

Referring to FIGS. 1 and 2, the base 2, the cylindrical sidewall 3, and the nozzle 4 form a one-piece container 1 in the illustrated embodiment. In FIGS. 1 and 2, the base 2 defines the bottom end of the container 1, and the nozzle 4 is located at the top end. The relative positions of the base 2 and the nozzle 4 of the container 1 will vary in use. The top end of the container 1 has a rim 5 that extends circumferentially around the opening. Preferably, the rim 5 (commonly called a bead or curl) defines a structure for securing the nozzle 4 to the container 1. When the nozzle 4 is secured to the rim 5 and closed as shown in FIGS. 1 and 2, the foamable food mixture is enclosed in the interior of the container. A material (not shown), such as a lathe cut gasket or plastic laminate film, may be provided to form a leak proof seal between the nozzle and the wall.

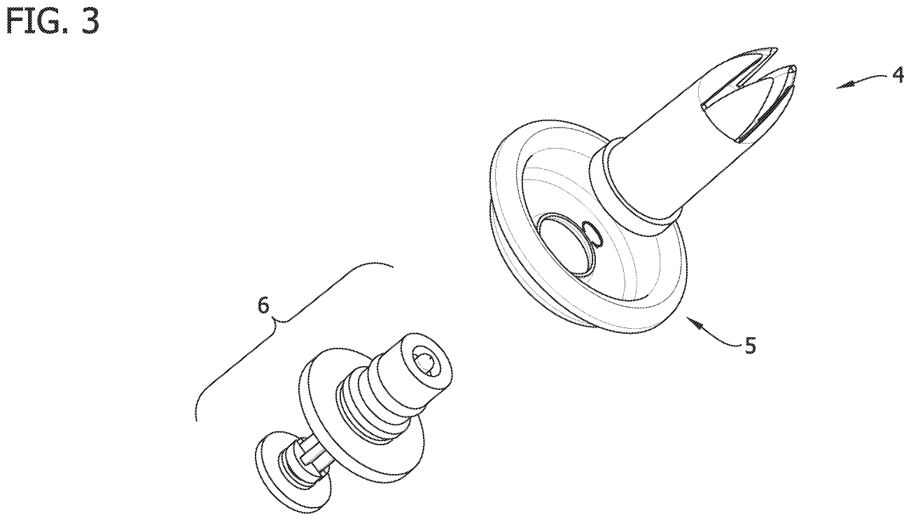

FIG. 3 provides an example of the nozzle component of the container. The nozzle 4 functions as an actuation mechanism that is configured to selectively actuate a valve, generally indicated collectively as 6. When actuated by the nozzle 4, the valve 6 opens to define an outlet of the container that fluidly couples an interior volume of the container 1 to the nozzle 4. When the valve 6 opens, the propellant in the foamable food mixture comprising a mixture of the diluted food product and propellant causes the foamable food mixture to dispense through the nozzle 4.

It is understood that many types of valves may be suitable for the described invention. For example, a tilt valve (industry name for a valve that is actuated by tilting it to the side to open, but it may also be actuated by vertical depression) or vertically actuated valve (also known as a spring valve or spray valve).

The single chamber containers, and nozzle or valve assemblies are commercially available from various sources including Clayton Corporation of Saint Louis, Mo.

### EXAMPLES

The following non-limiting examples are provided to further illustrate the invention.

### Example 1: Peanut Butter

Multiple peanut butter food products were prepared. A peanut butter food product was heated to between about 32° C. and 65° C. and mixed with water, as a diluent, to form a peanut butter food product composition (i.e., a diluted peanut butter food product) as set forth in Table 1 below. Peanut butter food product compositions were prepared ranging from 30 wt. % peanut butter to 80 wt. % peanut butter.

TABLE 1

| Peanut | | Total | Wt. % |
|---|---|---|---|
| Butter | Water | Weight | Peanut |
| (g) | (g) | (g) | Butter |
| 331.2 | 772.8 | 1104 | 30 |
| 441.6 | 662.4 | 1104 | 40 |
| 552 | 552 | 1104 | 50 |
| 662.4 | 441.6 | 1104 | 60 |
| 772.8 | 331.2 | 1104 | 70 |
| 883.2 | 220.8 | 1104 | 80 |

After the peanut butter food product was mixed with the water diluent, the peanut butter food product composition was allowed to cool to room temperature. The viscosity of each of the compositions were then measured at atmospheric conditions. The results are set forth below in Table 2.

TABLE 2

| | 30 wt. % | 40 wt. % | 50 wt. % | 60 wt. % | 70 wt. % | 80 wt. % |
|---|---|---|---|---|---|---|
| | Peanut | Peanut | Peanut | Peanut | Peanut | Peanut |
| | Butter | Butter | Butter | Butter | Butter | Butter |
| Viscosity | 92 | 112 | 25,170 | 135,300 | 1,050,000 | 1,670,000 |
| (cP) | | | | | | |

186 grams of the peanut butter food product composition was then loaded into a single chamber pressure-resistant container and combined with a nitrous oxide propellant to form a foamable peanut butter food mixture. The nitrous oxide readily dissolved into the peanut butter food product composition. Five foamable peanut butter food mixtures were prepared for each of the above peanut butter food product compositions. The amount of nitrous oxide absorbed by the compositions, reported in grams, is set forth below in Table 3.

TABLE 3

| | Amount of Nitrous Oxide (g) Absorbed | | | | | |
|---|---|---|---|---|---|---|
| | 30 wt. % | 40 wt. % | 50 wt. % | 60 wt. % | 70 wt. % | 80 wt. % |
| Sample | Peanut | Peanut | Peanut | Peanut | Peanut | Peanut |
| Number | Butter | Butter | Butter | Butter | Butter | Butter |
| 1 | 8.26 | 8.39 | 8.23 | 8.17 | 8.22 | 8.26 |
| 2 | 8.65 | 8.63 | 8.00 | 8.36 | 8.16 | 8.34 |
| 3 | 8.41 | 8.64 | 8.02 | 8.33 | 8.27 | 8.39 |
| 4 | 8.11 | 8.37 | 7.99 | 8.26 | 8.20 | 8.29 |
| 5 | 8.21 | 8.76 | 7.84 | 8.17 | 8.30 | 8.24 |

The foamable peanut butter food mixture was then dispensed from the single chamber pressure-resistant container at room temperature to determine if a foamed food product could be achieved. The results of dispensing the samples of Table 3 are set forth below in Table 4, wherein “pass” means that a foamed food product was formed and “fail” means that the food product was not dispensed as a foam.

TABLE 4

| | 30 | 40 | 50 | 60 | 70 | 80 |
|---|---|---|---|---|---|---|
| | wt. % | wt. % | wt. % | wt. % | wt. % | wt. % |
| | Peanut | Peanut | Peanut | Peanut | Peanut | Peanut |
| Sample | Butter | Butter | Butter | Butter | Butter | Butter |
| 1 | Pass | Pass | Pass | Pass | Pass | Fail |
| 2 | Pass | Pass | Pass | Pass | Pass | Fail |
| 3 | Pass | Pass | Pass | Pass | Pass | Fail |
| 4 | Pass | Pass | Pass | Pass | Pass | Fail |
| 5 | Pass | Pass | Pass | Pass | Pass | Fail |

### Example 2: Almond Butter

A similar experiment to Example 1 was performed using almond butter. An almond butter food product was heated to from about 32° C. to about 65° C. and mixed with water, as a diluent, to form an almond butter food product composition as set forth in Table 5 below. Almond butter food product compositions were prepared ranging from 30 wt. % almond butter to 80 wt. % almond butter.

TABLE 5

| Almond | | Total | Wt. % |
|---|---|---|---|
| Butter | Water | Weight | Almond |
| (g) | (g) | (g) | Butter |
| 331.2 | 772.8 | 1104 | 30 |
| 441.6 | 662.4 | 1104 | 40 |
| 552 | 552 | 1104 | 50 |
| 662.4 | 441.6 | 1104 | 60 |
| 772.8 | 331.2 | 1104 | 70 |
| 883.2 | 220.8 | 1104 | 80 |

After the almond butter food product was mixed with the water diluent, the almond butter food product composition was allowed to cool to room temperature. The viscosity of each of the almond butter food product compositions were then measured at atmospheric conditions. The results are set forth below in Table 6.

TABLE 6

| | 30 wt. % | 40 wt. % | 50 wt. % | 60 wt. % | 70 wt. % | 80 wt. % |
|---|---|---|---|---|---|---|
| | Almond | Almond | Almond | Almond | Almond | Almond |
| | Butter | Butter | Butter | Butter | Butter | Butter |
| Viscosity | 112 | 760 | 60,600 | 90,800 | 1,291,000 | 3,756,000 |
| (cP) | | | | | | |

All of the almond butter food product compositions formed a foamed food product when dispensed, except for the 80 wt. % almond butter food product.

### Example 3

A further experiment was conducted utilizing a peanut butter food product, peanut oil and water as a diluent, and the emulsifier lecithin.

The composition was prepared in accordance with the procedures of Example 1. The ingredients of the composition of this example are set forth below in Table 7.

TABLE 7

| | Amount | |
|---|---|---|
| | (g) | Wt. % |
| Peanut | 155.17 | 71.96% |
| butter | | |
| Peanut Oil | 41.3 | 19.15% |
| Water | 13.62 | 6.32% |
| Lecithin | 5.0 | 2.32% |

The food product composition resulted in a foamed food product exhibiting desirable characteristics when dispensed.

### Example 4

A further experiment was conducted to prepare certain containerized peanut butter foamable food compositions. Compositions were prepared having varying amounts of peanut butter food product, peanut oil, water, glycerin, and/or lecithin. For each composition, the water activity and viscosity was evaluated. “NM” indicates that a given value was not measured. Further, the compositions were evaluated for aesthetics, taste, and texture. Each composition was given a rating of 1, 3, or 9, with 9 being the highest rating. The results are reported below.

TABLE 8

| | Peanut | | | | | Water | |
|---|---|---|---|---|---|---|---|
| Compo- | Butter | Peanut | Water | Glycerin | Lecithin | Activity | Viscosity |
| sition | (g) | Oil (g) | (g) | (g) | (g) | (a_{w}) | (cP) |
| A | 155.0 | 0.0 | 20.0 | 20.0 | 5.0 | 0.55 | 36,000 |
| B | 160.0 | 0.0 | 20.0 | 20.0 | 0.0 | 0.57 | 32,000 |
| C | 195.0 | 0.0 | 0.0 | 0.0 | 5.0 | 0.35 | 12,000 |
| D | 175.0 | 0.0 | 0.0 | 20.0 | 5.0 | 0.28 | NM |
| E | 150.0 | 50.0 | 0.0 | 0.0 | 0.0 | 0.28 | 3,000 |
| F | 130.0 | 50.0 | 20.0 | 0.0 | 0.0 | 0.62 | 3,100 |
| G | 152.5 | 25.0 | 10.0 | 10.0 | 2.5 | 0.49 | 5,000 |
| H | 200.0 | 0.0 | 0.0 | 0.0 | 0.0 | 0.36 | 4,700 |
| I | 125.0 | 50.0 | 0.0 | 20.0 | 5.0 | 0.31 | 3,200 |
| J | 130.0 | 50.0 | 0.0 | 20.0 | 0.0 | 0.21 | 3,100 |
| K | 175.0 | 0.0 | 20.0 | 0.0 | 5.0 | 0.65 | NM |
| L | 110.0 | 50.0 | 20.0 | 20.0 | 0.0 | 0.59 | 4,500 |
| M | 152.5 | 25.0 | 10.0 | 10.0 | 2.5 | 0.51 | 13,000 |
| N | 105.0 | 50.0 | 20.0 | 20.0 | 5.0 | 0.56 | 4,400 |
| O | 180.0 | 0.0 | 0.0 | 20.0 | 0.0 | 0.32 | NM |
| P | 180.0 | 0.0 | 20.0 | 0.0 | 0.0 | 0.56 | NM |
| Q | 152.5 | 25.0 | 10.0 | 10.0 | 2.5 | 0.53 | 18,000 |
| R | 125.0 | 50.0 | 20.0 | 0.0 | 5.0 | 0.55 | 4,200 |
| S | 145.0 | 50.0 | 0.0 | 0.0 | 5.0 | 0.41 | 2,200 |

TABLE 9

| | Aesthetic | Taste | Texture |
|---|---|---|---|
| | Score | Score | Score |
| Composition | (1-3-9) | (1-3-9) | (1-3-9) |
| A | 1 | 3 | 9 |
| B | 1 | 3 | 9 |
| C | 9 | 9 | 9 |
| D | 9 | 9 | 1 |
| E | 3 | 1 | 9 |
| F | 3 | 3 | 9 |
| G | 9 | 9 | 9 |
| H | 9 | 9 | 9 |
| I | 3 | 3 | 3 |
| J | 9 | 9 | 1 |
| K | 9 | 9 | 3 |
| L | 3 | 9 | 9 |
| M | 9 | 9 | 9 |
| N | 9 | 3 | 9 |
| O | 9 | 9 | 3 |
| P | 9 | 9 | 9 |
| Q | 9 | 9 | 3 |
| R | 3 | 3 | 9 |
| S | 1 | 1 | 9 |

Although several composition falling outside of the bounds of the invention reported aesthetic, taste, or texture scores of 9, these compositions were otherwise commercially unacceptable. For example, the compositions falling outside of the bounds of the invention were not storage stable for an acceptable period of time, did not maintain a foamed state for an acceptable period of time, etc.

When introducing elements of the invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

Having described the invention in detail, it will be apparent that modifications and variations are possible without departing from the scope of the invention defined in the appended claims.

As various changes could be made in the above constructions, products, and methods without departing from the scope of the invention, it is intended that all matter contained in the above description and shown in the accompanying drawings shall be interpreted as illustrative and not in a limiting sense.

1. A containerization system for dispensing a foamed food product comprising:
a single chamber pressure-resistant container comprising a base, a sidewall, and a nozzle;
a propellant; and
a food product composition comprising:
from about 30 wt. % to about 80 wt. % of a food product capable of separating into an oil phase and at least one additional phase; and
from about 20 wt. % to about 70 wt. % of a diluent;
wherein:
the propellant and the food product composition are sealed within the single chamber of the container, and at least a portion of the propellant is capable of settling above the food product composition when the container is in an unshaken and upright position;
the oil phase does not leak from the nozzle of the container during storage of the system;
the food product composition is capable of forming a foamable food mixture with at least a portion of the propellant when the container is shaken;
the foamable food mixture is capable of flowing toward the nozzle of the container upon inversion of the container after the container is shaken so that the foamable food mixture is dispensed from the nozzle when the nozzle is activated; and
the foamable food mixture is capable of expanding in volume when it is dispensed from the nozzle, forming a foamed food product.

2. The system of claim 1 wherein the food product composition comprises from about 30 to about 75 wt. % of a food product.

3. The system of claim 1 wherein the food product composition comprises from about 20 wt. % to about 70 wt. % of the diluent.

4. The system of claim 1 wherein the diluent comprises water and oil.

5. The system of claim 4 wherein the oil is selected from the group consisting of peanut oil, rapeseed oil, soybean oil, cottonseed oil, palm oil, sunflower oil, coconut oil, or combinations thereof.

6. The system of claim 4 wherein the diluent comprises from about 50 wt. % to about 99 wt. % of oil based on the total weight of the diluent.

7. (canceled)

8. (canceled)

9. The system of claim 1 wherein the propellant comprises air, carbon dioxide, nitrogen gas, nitrous oxide, 1,1,1,2-tetrafluoroethane, or any combination thereof.

10. (canceled)

11. (canceled)

12. The system of claim 1 wherein the food product comprises chickpeas, soybeans, peanuts, or any combinations thereof.

13. The system of claim 1 wherein the food product comprises peanut butter, almond butter, cashew butter, pecan butter, coconut butter, hazelnut butter, guacamole or an avocado-based food product, cream cheese, sour cream, hummus, or any combination thereof.

14. The system of claim 13 wherein the food product comprises peanut butter.

15. (canceled)

16. The system of claim 13 wherein the food product comprises an avocado-based food product.

17. The system of claim 1, wherein the food product composition further comprises peanuts, almonds, cashews, hazelnuts, brazil nuts, chickpeas, a sugar, molasses, chocolate, chia seeds, flax seeds, sunflower seeds, pumpkin seeds, sesame seeds, coconut, or any combination thereof.

18. The system of claim 1 wherein the food product composition further comprises one or more additive selected from the group consisting of a sweetener, emulsifier, preservative, flavorant, colorant, humectant, wetting agent, binder, stabilizer, rheology modifying agent, oil, or combinations thereof.

19. The system of claim 1 wherein the food product composition has a water activity of about 0.8 or less.

20. The system of claim 1 wherein the food product composition is an emulsion.

21. The system of claim 1 wherein the food product composition is not an emulsion.

22. (canceled)

23. (canceled)

24. The system of claim 1 wherein the viscosity of the food product composition prior to being sealed in the container is from about 10,000 to about 200,000 cP when measured at a temperature of 25° C. and an atmospheric pressure of 1 bar.

25. The system of claim 1 wherein the contents of the containerization system are storage stable for at least about 1 week when measured at a temperature of 25° C. and an atmospheric pressure of 1 bar.

26-28. (canceled)

29. The system of claim 1 wherein the dispensed foamed food product maintains a foam state for at least about 5 minutes.

30. (canceled)

31. A containerization system for dispensing a foamed food product comprising:
a single chamber pressure-resistant container comprising a base, a sidewall, and a nozzle;
a propellant; and
a food product composition comprising:
from about 30 wt. % to about 80 wt. % of a food product comprising a sugar; and
from about 20 wt. % to about 70 wt. % of a diluent comprising water and oil;
wherein:
the propellant and the food product composition are sealed within the single chamber of the container, and at least a portion of the propellant is capable of settling above the food product composition when the container is in an unshaken and upright position;
the food product does not leak from the nozzle of the container during storage of the system;
the food product composition is capable of forming a foamable food mixture with at least a portion of the propellant when the container is shaken;
the foamable food mixture is capable of flowing toward the nozzle of the container upon inversion of the container after the container is shaken so that the foamable food mixture is dispensed from the nozzle when the nozzle is activated; and
the foamable food mixture is capable of expanding in volume when it is dispensed from the nozzle, forming a foamed food product.
